(19) United States
(12) Patent Application Publication
(10) Pub. No.: US 2010/0113986 A1
(43) Pub. Date: May 6, 2010

(54) WALKING ASSIST APPARATUS

(75) Inventors: Jun ASHIHARA, Wako-shi (JP); Takeshi MORIOKA, Wako-shi (JP)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: HONDA MOTOR CO., LTD., Tokyo (JP)

(21) Appl. No.: 12/611,386

(22) Filed: Nov. 3, 2009

(30) Foreign Application Priority Data
Nov. 6, 2008 (JP) 2008-285946

(51) Int. Cl. A61H 1/00

(52) U.S. Cl. 601/5

(57) ABSTRACT

In a walking assist apparatus having a support member supporting an user, a pair of shoe units accommodating the user's feet, a pair of leg links each having a first link connected to the support member and a second link connected to each shoe unit, a pair of actuators each connected to the first and second links, a controller controlling operation of the actuators and a battery and assists walking of the user by producing relative movement between the first and second links, there are equipped with a primary coil installed in a floor on which the user walks on, a secondary coil installed in one of the shoe units and is supplied with non-contact supply of power from the primary coil, and a charging circuit charging the battery with rectified direct current output.

### BACKGROUND OF THE INVENTION

1. Field of the Invention

This invention relates to a walking assist apparatus, more particularly to a battery charging device for a walking assist apparatus worn on the lower body of a human being (user) to assist his/her walking.

2. Description of the Related Art

Recently reported walking assist apparatuses of this type include, for instance, the one according to the technology set out in Japanese Laid-Open Patent Application No. 2007-20909 (Patent Document 1).

The walking assist apparatus of the reference is equipped with a support member capable of supporting the user, shoe units capable of accommodating the user's feet, leg links having first links connected to the support member through joints and second links connected to the shoe units through second joints, actuators connected to the first links and second links, a controller that controls the operation of the actuators, and a battery, which walking assist apparatus assists the user walk by operating the actuators to produce relative movement between the first and second links.

When the remaining battery charge of the walking assist apparatus set out in the reference 1 runs low, the battery is recharged either after removal from the apparatus or through contacts as installed in the apparatus. In either case, the battery is troublesome to recharge.

### SUMMARY OF THE INVENTION

The object of this invention is therefore to overcome this drawback by providing a walking assist apparatus equipped with actuators, a controller for controlling the operation of the actuators, and a battery, in which charging of the battery is made simple.

In order to achieve the object, this invention provides a walking assist apparatus, having: a support member that is adapted to support an user; a pair of shoe units that are adapted to accommodate feet of the user: a pair of leg links each having a first link connected to the support member through a first joint and a second link connected to each of the shoe units through a second joint; actuators each connected to the first links and second links: a controller that controls operation of the actuators; and a battery that is adapted to supply operating power at least one of the actuators and the controller; and assists walking of the user by operating the actuators to produce relative movement between the first and second links; wherein the improvement comprises: a primary coil installed in a floor on which the user walks on; a secondary coil that is installed in at least one of the shoe units and is supplied with non-contact supply of power by magnetic induction from the primary coil; and a charging circuit that charges the battery with direct current output rectified by a rectifier circuit.

### BRIEF DESCRIPTION OF THE DRAWINGS

The above and other objects and advantages of the invention will be more apparent from the following description and drawings in which:

FIG. 1 is a perspective view of a walking assist apparatus according to an embodiment of the invention, showing its overall configuration including a battery charging device;

FIG. 2 is a perspective view of the apparatus shown in FIG. 1;

FIG. 3 is a side view of the apparatus shown in FIG. 2;

FIG. 4 is a front view of the apparatus shown in FIG. 2;

FIG. 5 is a side sectional view of a drive mechanism, first link and other components shown in FIG. 2, etc.;

FIG. 6 is a plan view of a loop coil shown in FIG. 1;

FIG. 7 is a sectional view along VII-VII in FIG. 6;

FIG. 8 is a side view of a shoe unit shown in FIG. 1. etc.;

FIG. 9 is a plan view of the shoe unit shown in FIG. 8;

FIG. 10 is a plan view of the shoe unit shown in FIG. 8;

FIG. 11 is a set of explanatory views showing the apparatus illustrated in FIG. 1, etc., assisting the walking (movement) of a worker (user) engaged in automobile assembly;

FIG. 12 is a time chart showing the relationship between the assembly work illustrated in FIG. 11 and remaining battery charge and the like;

FIG. 13 is a set of explanatory views showing another example of deployment of the loop coil illustrated in FIG. 1 in the case where the apparatus provides walking (movement) assistance to a worker (user) making the rounds of different work sites inside a facility;

FIG. 14 is a time chart showing the relationship between tasks illustrated in FIG. 13 and remaining battery charge and the like; and

FIG. 15 is an explanatory view showing another example of the loop coil shown in FIG. 1.

### DETAILED DESCRIPTION OF THE PREFERRED EMBODIMENT

A preferred embodiment of the walking assist apparatus according to the invention is explained with reference to the attached drawings in the following.

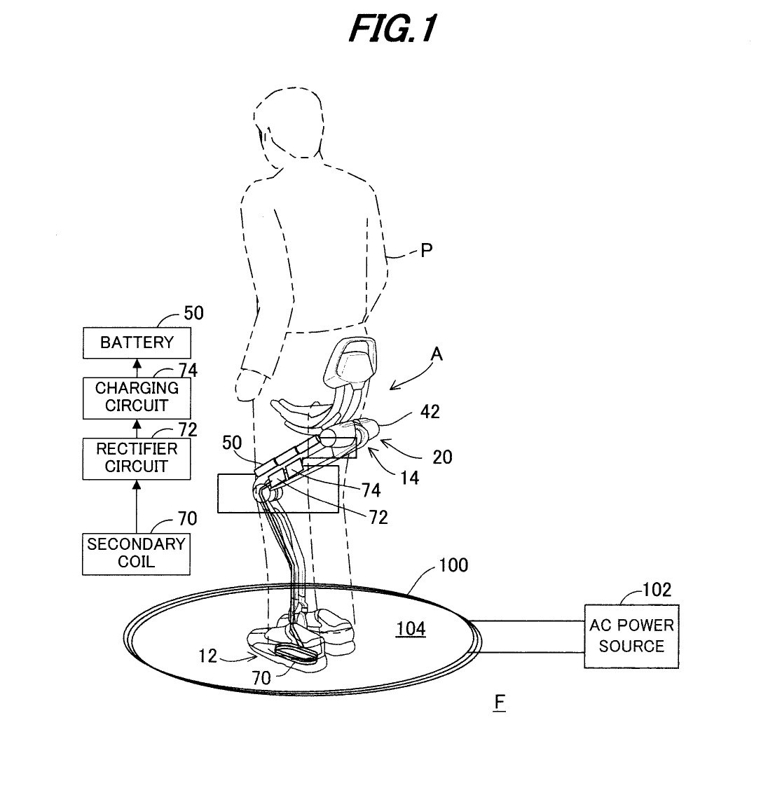

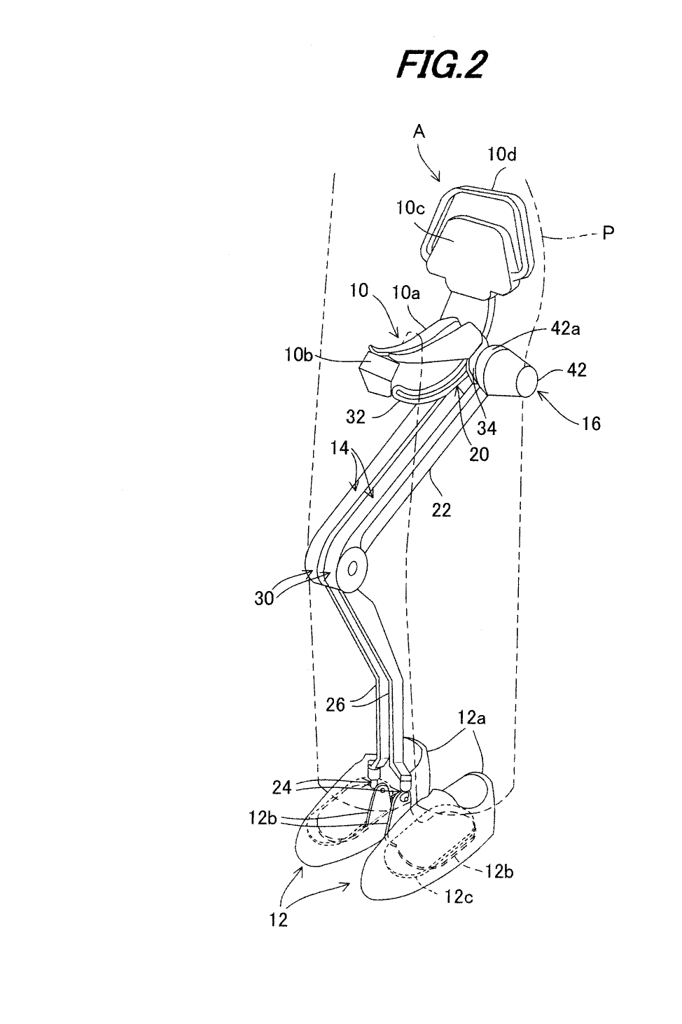

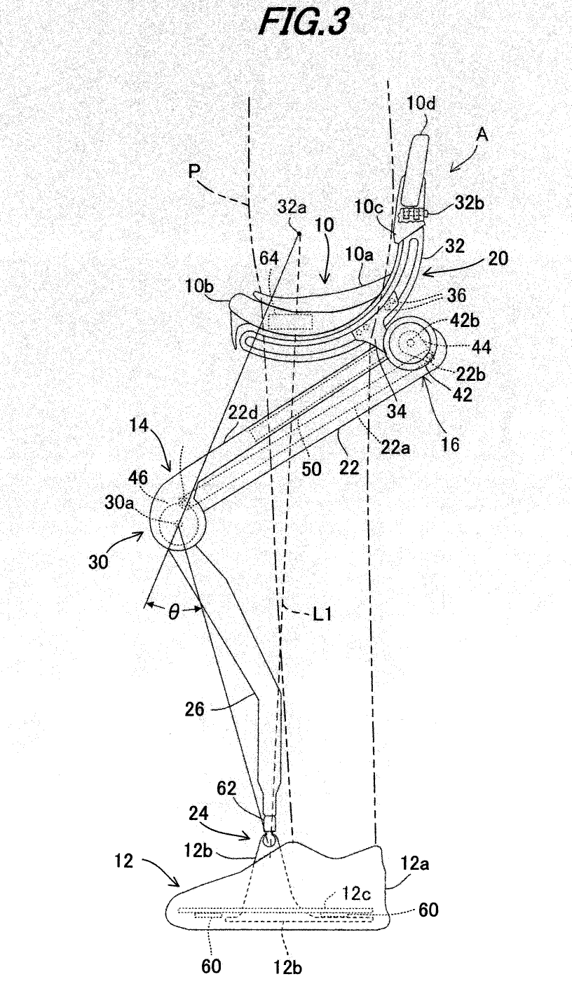

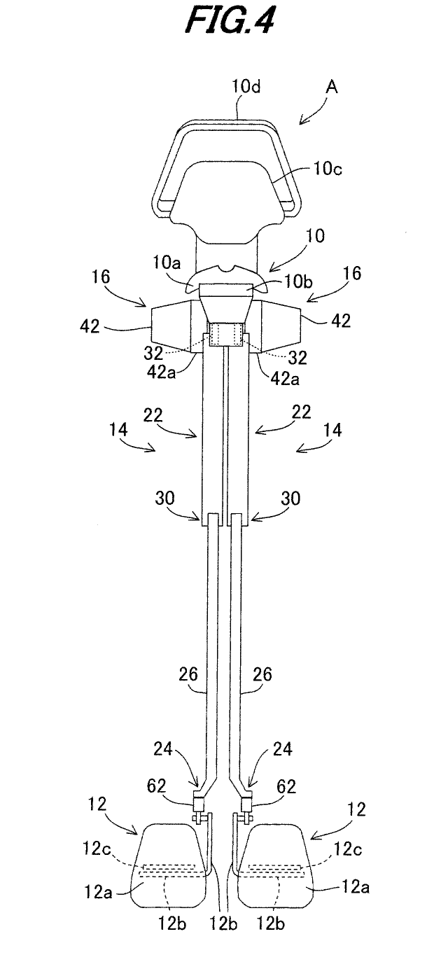

FIG. 1 is an explanatory view of the walking assist apparatus according to an embodiment of the invention, showing its overall configuration including a battery charging device. FIG. 2 is a perspective view of the walking assist apparatus shown in FIG. 1. FIG. 3 is a side view thereof FIG. 4 is a front view thereof.

The walking assist apparatus will first be explained with references to FIGS. 2 to 4. The walking assist apparatus, designated A in the drawings, comprises a support member 10 that supports a user (human being) P seated astraddle thereon, a pair of left and right shoe units 12 to be worn on the left and right feet of the user P, a pair of left and right leg links 14 provided between the support member 10 and the shoe units 12, and drive mechanisms 16. The walking assist apparatus is fastened to the lower body of the user P by a belt (not shown) provided on the support member 10 and assists the user P walk.

The left and right leg links 14 are made of aluminum. Each comprises a first link (thigh link) 22 connected to the support member 10 through a first joint 20 (corresponding to the human hip joint), a second link (shank link) 26 connected to the associated shoe 12 through a second joint 24 (corresponding to the human ankle joint), and a third joint 30 (corresponding to the human knee) connecting the first link 22 and second link 26.

The first link 22 and second link 26 of the leg link 14 are connected to the associated drive mechanism 16 which moves (drives) them relative to each other with the third joint 30 as a pivot point (i.e., about the third joint 30).

The support member 10 comprises a saddle-like seat 10a that supports the user P seated astraddle thereon, a support frame 10b located near the seat 10a to support it, and a back rest 10c rising from the support frame 10b to above the rear end (as viewed by the user P) of the seat 10a to contact the lower back of the user P. A grip 10d that can be grasped by the user P is attached to the back rest 10c.

As best shown in FIG. 3, the support frame 10b of the support member 10 is forward-canted overall (in the direction of forward movement when the user P sits on the seat 10a). The seat 10a is made of a cushioning material, and the support frame 10b and back rest 10c are made of materials of higher rigidity than the seat 10a.

The first joints 20 that connect the leg links 14 and support member 10 each comprises an arc-shaped guide rail 32 fastened to the support member 10 and a slider 34 that engages with the guide rail 32 and is fastened to one end of the associated leg link 14. The guide rails 32 and sliders 34 are made of aluminum.

A plurality of rollers 36 are attached to each slider 34. The rollers 36 are fitted in a groove formed in the guide rail 32 to roll along the groove. Therefore, as shown in FIG. 2, each slider 34 engages with the associated guide rail 32 to be movable alone it.

In other words, each leg link 14 can swing about the center of curvature 32a (swing pivot point) of the associated guide rail 32 in the longitudinal direction of the support member 10. Moreover, the guide rails 32 are pivotally supported on the back rest 10c of the support member 10 by a support shaft 32b installed sideways to extend in the longitudinal direction of the support member 10, thereby enabling the guide rails 32 to swing about the support shaft 32b in the lateral direction of the support member 10.

Thus the leg links 14 can swing forward and backward (in the direction of user P travel) about the centers of curvature 32a of the guide rails 32 as the swing pivot points, so that when the point of action of the upper body weight of the user P relative to the support member 10 shifts forward of the swing pivot points 32a to make the support member 10 descend forward, since the swing pivot points 32a is located above the support member 10 in the gravitational direction, the point of action of the body weight is displaced rearward below the swing pivot point 32a, thereby shortening the fore-aft distance between the swing pivot point 32a and the point of action of the body weight to reduce rotational moment acting on the support member 10.

Next, when the point of action of the body weight has moved as far as directly under the swing pivot point 32a, the rotational moment acting on the support member 10 becomes zero and the support member 10 becomes stable. Thus, the support member 10 converges on the stable state by itself, so that the support member 10 does not shift forward or backward at the location of the user P's crotch.

The guide rails 32 are enabled to swing sideways (relative to the direction of user P travel) about the swing pivot point (support shaft) 32b, so that the leg links 14 can swing sideways to make it possible for the user P to swing the legs outward at will.

Each of the shoe units 12 comprises a shoe 12a to be worn on a foot of the user P, an L-shaped (as viewed from the front looking rearward along the path of user P travel) connecting member 12b made of carbon material and extending to inside the shoe 12a for enabling the corresponding foot of the user P to rest thereon, and an insole 12c of urethane rubber or similar rubbery elastic material that lies on the upper surface of the connecting member 12b. The second link 26 of each leg link 14 is connected to the associated connecting member 12b through the associated second joint 24 of triaxial structure.

FIG. 5 is a side sectional view of the drive mechanisms 16 and the associated first link 22, etc.

The first link 22 and second link 26 of the leg link 14 are connected to the associated drive mechanism 16. The drive mechanism 16 comprises an actuator (electric motor) 42 located near the upper end of the first link 22, an output shaft 42b for outputting the rotation of the motor 42 trough reduction gearing 42a, a drive crank arm 44 fastened to the output shaft 42b. and a driven crank arm 46 fastened to the second link coaxially with a joint shaft 30a of the third joint 30.

The drive crank arm 44 and the driven crank arm 46 are interconnected by the first link 22. Specifically, the first link 22 is connected by a rod 22a pivotally attached at one end to the drive crank arm 44 by a pivot 22b and at the other end to the driven crank arm 46 by a pivot 22c, thereby establishing rotatable connections. Thus, more specifically, the first link 22 is constituted as a quadric chain comprising the first link 22, the drive crank arm 44, the rod 22a and the driven crank arm 46.

As shown in FIG. 5, the first link 22 is disposed so that a line drawn to connect its pivot 22b on the drive crank arm 44 with its pivot 22c on the driven crank arm 46 intersects a line drawn to connect the output shaft 42b of the actuator 42 with the joint shaft 30a of the third joint 30. A battery 50 housed within a cover 22d of the first link 22 supplies power for operating the motors 42 and the like.

The walking assist control for assisting the user P walk will be explained next.

Each shoe unit 12 is provided on the undersurface of its insole 12c with a pair of front and rear single-axis force sensors 60 that produce outputs proportional to the loads acting at the middle toe (MP (metacarpophalangeal) joint) region and heel region of the user P's foot. In addition, each second joint 24 incorporates a biaxial force sensor 62 that produces an output proportional to the force acting on the second joint 24 (resultant of the forces produced by the weights of the support member 10 and the associated leg link 14).

The outputs of the sensors 60 and 62 are sent to a controller 64 housed inside the support frame 10b of the support member 10. The controller 64 is configured as a microcomputer equipped with a CPU, ROM, RAM and input-output (I/O) ports. It is supplied with operating power from the battery 50 and executes assist control for controlling the operation of the motors 42 so as to produce assist forces that assists the user P walk.

More specifically, the controller 64 multiplies the value of the assist forces set in advance by the proportion of the total load acting on the feet of the user P that is borne by the individual feet calculated from the outputs of the force sensors 60, and defines the products obtained as the desired values of the assist forces to be produced in the respective leg links 14. For example, where the load (weight) of the apparatus A is 60 (N) and the assist force is 30 (N), the set value is 90 (N).

Each assist force acts along the line in FIG. 3 (designated L1; hereinafter sometimes called “reference line”) that interconnects the fore-aft swing pivot point 32a of the leg link 14 in the first joint 20 and the fore-aft swing pivot point of the leg link 14 in the second joint 24. So the controller 64 detects the actual assist force acting along the reference line L1 based on the output of the force sensor 62 and controls the operation of the motor 42 of the associated drive mechanisms 16 to make the actual assist force detected equal to the desired value.

More specifically, when the user P is supported as seated on the seat 10a of the support member 10, the controller 64 operates the actuators (motors) 42 of the drive mechanisms 16 to produce relative movement between the first links 22 and the second links 26 of the leg links 14 about the joint shafts 30a of the third joints 30, thereby helping the user P walk by producing supporting forces, i.e., assist forces, to support at least part of the user P's body weight.

The assist forces produced in the leg links 14 are transmitted through the support member 10 to the trunk of the user P to assist walking by reducing the load acting on the legs of the user P. The user P is presumed to be a worker at a factory or the like who, as discussed later, works in a standing posture.

The explanation of FIG. 1 will be resumed. The walking assist apparatus A according to this embodiment is equipped with a secondary coil 70 that is installed in one of the shoe units 12 and is supplied with non-contact supply of power by magnetic induction from a loop or circular coil (primary coil) 100 installed in the floor F on which the user walks on, and a rectifier circuit 72 that rectifies the output of the secondary coil 70 and a charging circuit 74 that charges the battery 50 with the direct current output rectified by the rectifier circuit 72.

As illustrated, the loop coil 100 is a coil of a suitable number of turns wound in a circle of around 1 meter diameter so that the shoe units 12 of the walking assist apparatus A can fit inside it with room to spare. The loop coil 100 is connected to a commercial or other AC power source 102.

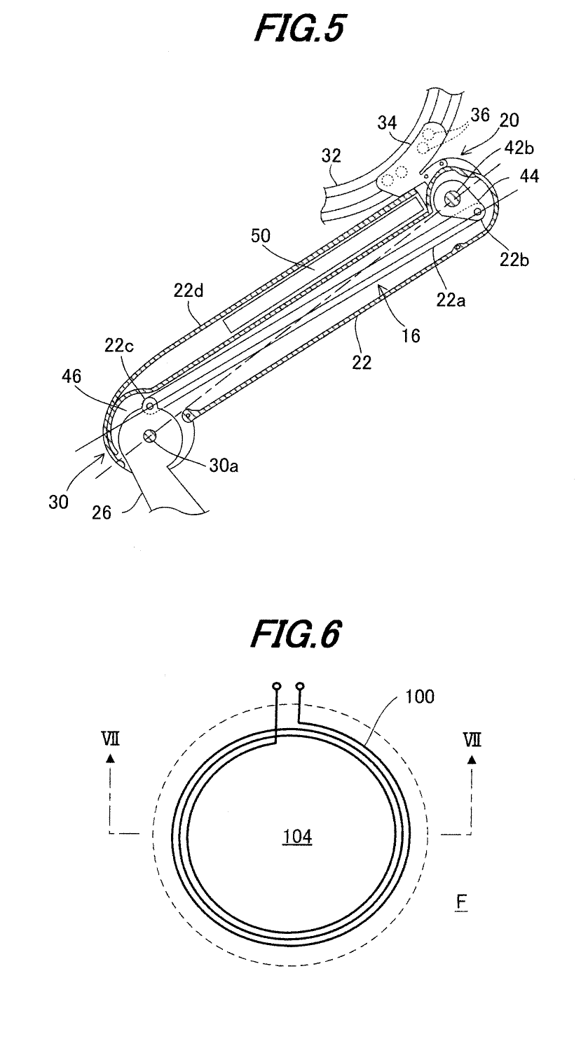

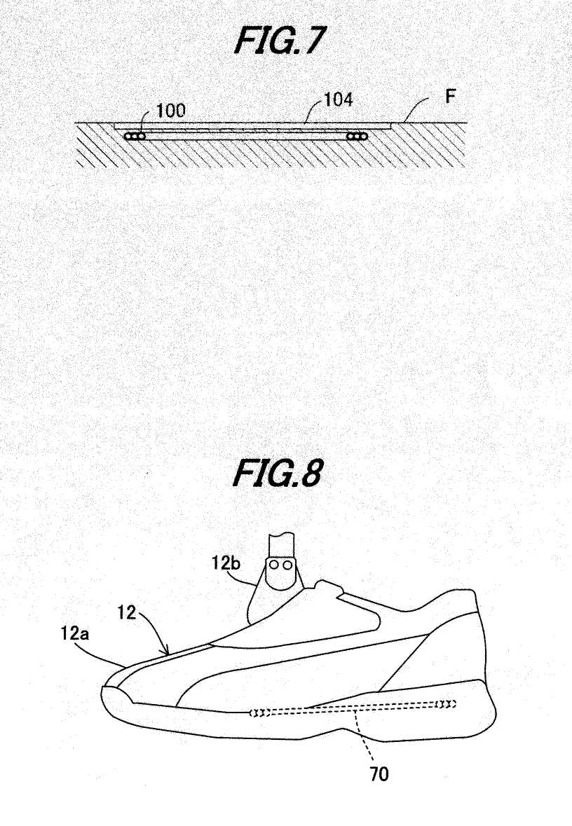

FIG. 6 is a plan view of the loop coil 100 in the floor F, and FIG. 7 is a sectional view along VII-VII in FIG. 6.

As shown in FIGS. 6 and 7, the loop coil 100 is embedded in the floor F, made of concrete or the like, in a workspace at a factory or other such facility. It is covered with a circular cover 104 made of a non-dielectric material like rubber.

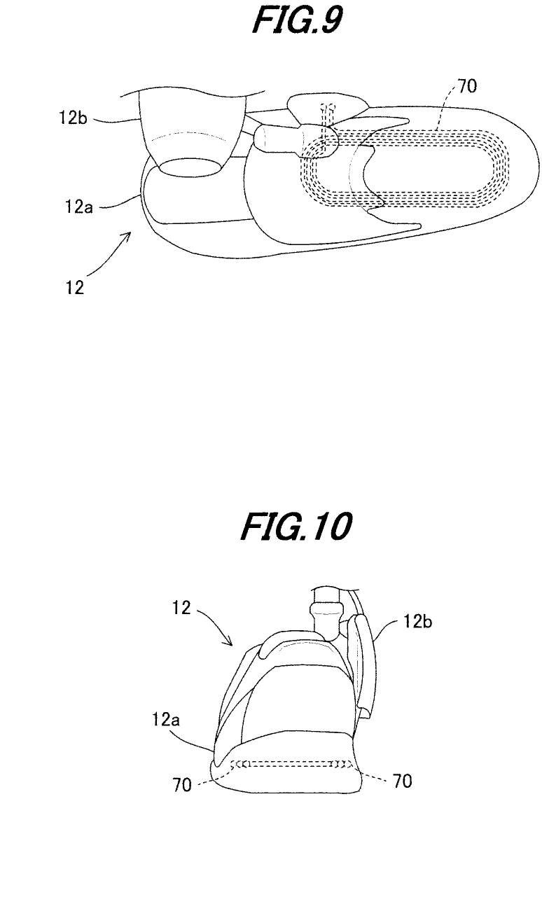

FIGS. 8, 9 and 10 are side, plan and rear views of the shoe unit 12.

As illustrated, the secondary coil 70 is a coil of a suitable number of turns wound in an oval or rectangle with a breadth (minor axis) of around 4 cm. It is accommodated under the insole 12c of either the left or right shoe unit 12. User walking passes through alternate two-leg support phases and one-leg support phases (when the other leg is in the swing phase). The toe end of the shoe 12a on the supporting leg side greatly deforms during the transition from the two-leg support phase to the one-leg support phase, while the heel end of the shoe 12a on the swinging leg side deforms during the transition from heel contact to the two-leg support phase.

The secondary coil 70 is accommodated at a location close to the heel end. i.e., at or near the heel end of the shoe 12a because the heel end deforms less than the toe end. Moreover, this arrangement ensures that electromagnetic induction is not impaired even if the toe of the shoe 12a is fitted with a metal toe safety protector (not shown).

Power transmitted from the loop coil 100 to the secondary coil 70 by non-contact electromagnetic induction is passed through the rectifier circuit 72 and charging circuit 74 to charge the battery 50. As shown in FIG. 1, the rectifier circuit 72 for rectifying the output of the secondary coil 70 and the charging circuit 74 for charging the battery 50 are accommodated in the first link 22 near the battery 50.

The loop coil 100 is supplied with relatively large current from the AC power source 102. The transmission of this power through the secondary coil 70, rectifier circuit 72 and charging circuit 74 to the battery 50 therefore enables quick charging of the battery 50.

The installation of the loop coil 100 will be explained.

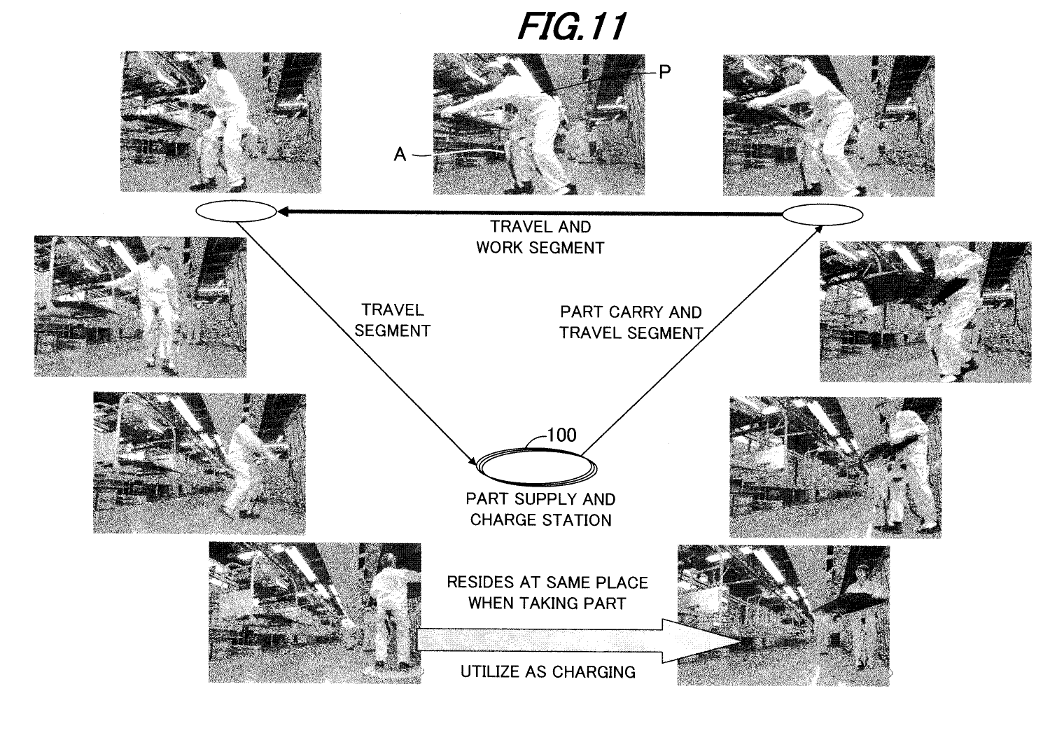

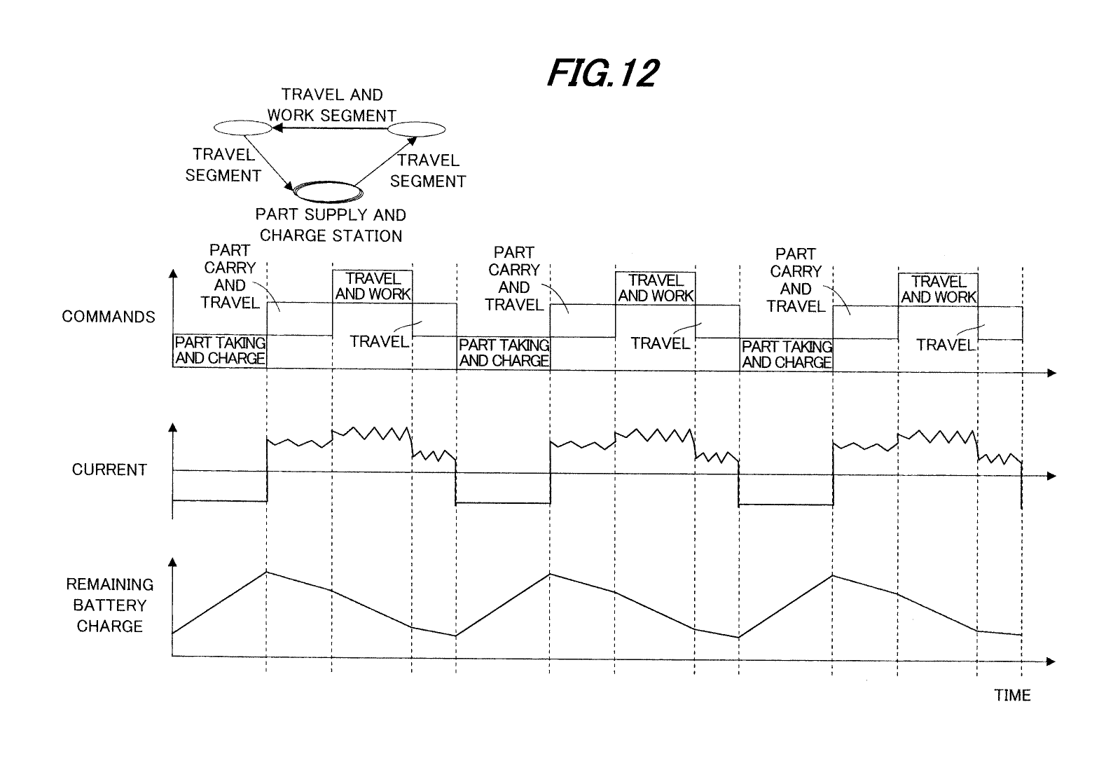

FIG. 11 is an explanatory view showing the walking assist apparatus A assisting the walking (movement) of a worker (user) P engaged in automobile assembly. FIG. 12 is a time chart showing the relationship between the assembly work and remaining battery charge and the like.

The automobile assembly work shown in FIG. 11 involves regular movement through a circuit (travel circuit) including a travel segment to a part supply station, a travel segment during which the worker carries the supplied part, and a travel and work segment during which the user moves and works. In the illustrated case, the loop coil 100 is installed in the floor of the part supply station midway of the circuit.

In this arrangement, the user (worker) P is made to reside at the site of loop coil 100 for at least a predetermined time (e.g., 20 seconds) while being supplied with the part. The battery 50 can be charged utilizing this residence time.

Moreover, the site of loop coil 100 installation is determined in the light of the capacity of the battery 50, in other words, the site of the midway of the circuit is determined according to the capacity of the battery 50. Therefore, as shown in FIG. 12, the battery 50 is recharged before its remaining charge falls below a predetermined value, so that the worker P can continue the work shown in FIG. 11 without interruption except when residing at the part supply station.

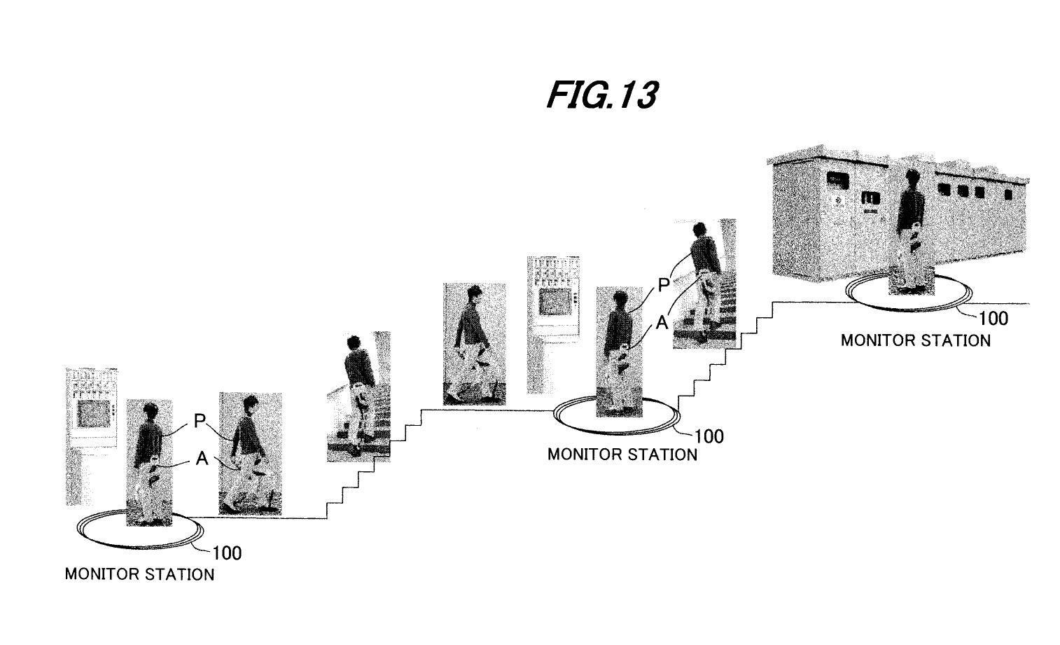

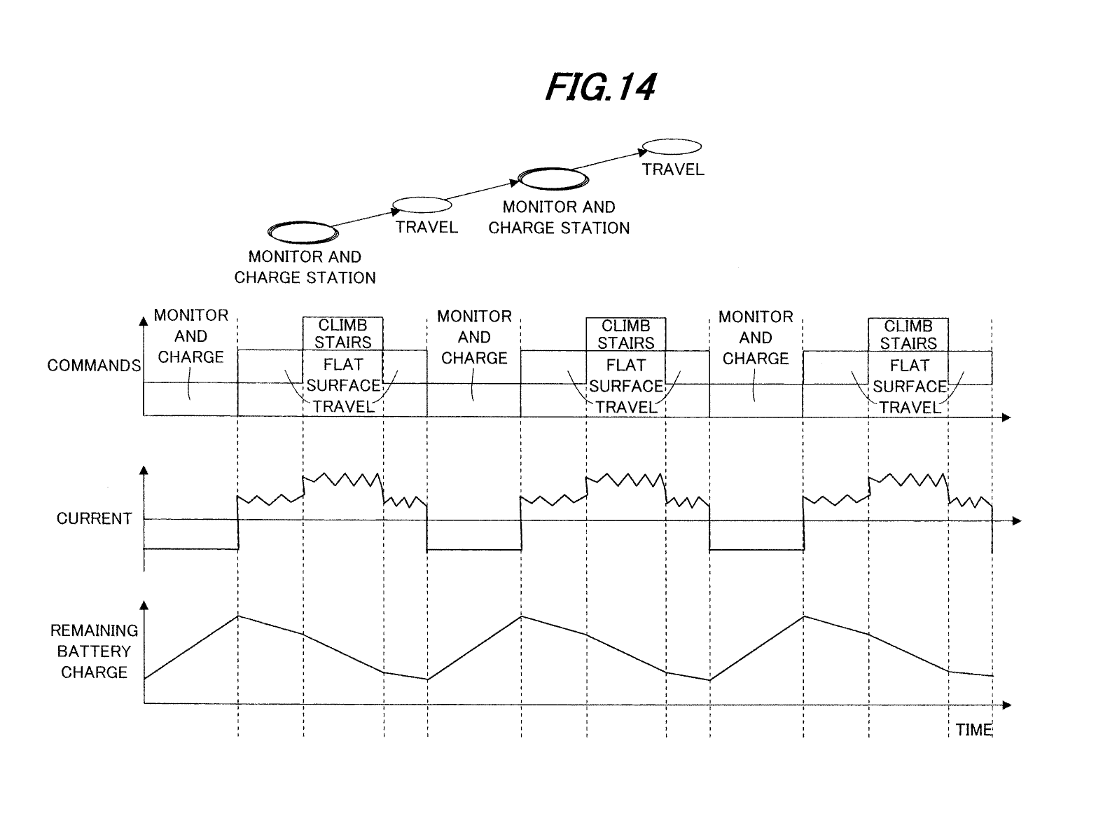

FIG. 13 is an explanatory view showing another example of loop coil 100 deployment in the case where the walking assist apparatus A provides walking (movement) assistance to a worker (user) P making the rounds of different work sites inside a facility. FIG. 14 is a time chart showing the relationship between the tasks and remaining battery charge and the like.

In the work shown in FIG. 13, the worker P monitors at a monitor station on the first floor, next climbs stairs and moves to and monitors at a monitor station on the second floor, and then climbs stairs and moves to and monitors at a monitor station on the third floor. The loop coil 100 is therefore deployed at each monitor station and the worker P is made to reside thereat for at least a predetermined time to be recharged with the battery 50. Thus, also in this work, the loop coil 100 is installed in the floor at a location midway of the travel circuit, when the worker P makes regular movement through the travel circuit.

Therefore, as shown in FIG. 14, the battery 50 is recharged before its remaining charge falls below a predetermined value, so that the worker P can continue the work shown in FIG. 13 without interruption except when residing at the monitoring sites.

As stated above, the embodiment is configured to have a walking assist apparatus A, having: a support member (10) that is adapted to support an user (P); a pair of shoe units (12) that are adapted to accommodate feet of the user; a pair of leg links (14) each having a first link (22) connected to the support member through a first joint (20) and a second link (26) connected to each of the shoe units through a second joint (24); actuators (42) each connected to the first links and second links; a controller (64) that controls operation of the actuators; and a battery (50) that is adapted to supply operating power at least one of the actuators and the controller; and assists walking of the user by operating the actuators to produce relative movement between the first and second links; wherein the improvement comprises: a primary coil (loop coil) 100 installed in a floor (F) on which the user walks on; a secondary coil (70) that is installed in at least one of the shoe units (12), more precisely the shoe (12a) and is supplied with non-contact supply of power by magnetic induction from the primary coil; and a charging circuit (74) that charges the battery with direct current output rectified by a rectifier circuit (72). With this, the user can be charged with the battery if he resides or stands at the site on the floor F where the secondary coil 70 is installed, thereby enabling to make charging (recharging) of the battery simple.

In the apparatus, the secondary coil (70) is installed at a location close to a heel end of the one of the shoe units (12), more precisely shoe (12a). With this, in addition to the effects mentioned above, it becomes possible to protect the damage of the secondary coil since the heel end deforms less than the toe end. Moreover, this arrangement ensures that electromagnetic induction is not impaired even if the toe of the shoe 12a is fitted with a metal toe safety protector.

In the apparatus, the primary coil (100) is installed in the floor (F) at a location midway of a travel circuit (such as a part supply station or monitor station), when the user makes regular movement through the travel circuit. With this, in addition to the effects mentioned above, the user can continue the work while being charged with the battery 50 during the work.

In the apparatus, a site of the midway is determined according to a capacity of the battery (50). With this, in addition to the effects mentioned above, it becomes possible to decrease the capacity of the battery 50 and as a result, it becomes possible to decrease the entire weight of the apparatus A and decrease the energy consumption.

In the apparatus, the secondary coil (70) is wound in a circle such that the at least one of the shoe units (12) fits in the circle with room to spare. With this, in addition to the effects mentioned above, the charging (recharging) of the battery 50 can be further facilitated.

In the apparatus, the primary coil (100) is embedded in the floor and covered by a cover (104), or the primary coil (100) is installed in the floor inside a carpet (106). With this, in addition to the effects mentioned above, the primary coil 100 can be protected from the damage.

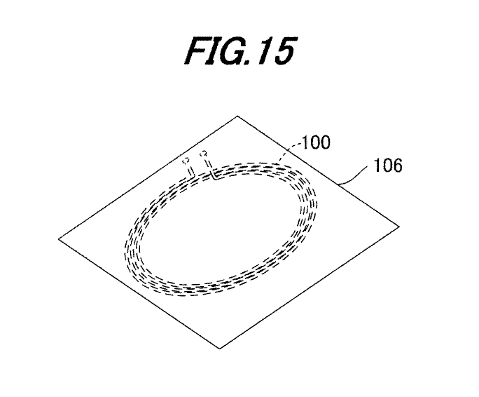

Although this invention has been explained with reference to an embodiment, this invention is not limited to the embodiment. For example, the foregoing embodiment is configured to embed the loop coil 100 in the floor F and cover it with the cover 104, but it is also acceptable, as shown in FIG. 15, to install or embed the loop coil 100 in the floor inside a carpet 106.

In addition, although it has been explained that electric motors are used as the actuators 42 and that the battery 50 supplies them with operating power, it is acceptable for the actuators 42 to be hydraulic/pneumatic devices whose operation is controlled by a microcomputer-based computer system or the like supplied with operating power from the battery 50.

Further, although it has been explained that the secondary coil 70 is provided in only one of the left and right shoe units 12, secondary coils 70 can be provided in both the left and right shoe units 12.

Moreover, the support member 10 is not limited to a structure enabling use in a seated posture but can be of a structure using a belt such as taught by Japanese Laid-Open Patent Application No. 2006-187348.

Japanese Patent Application No. 2008-285946 filed on Nov. 6, 2008, is incorporated by reference herein in its entirety.

While the invention has thus been shown and described with reference to specific embodiments, it should be noted that the invention is in no way limited to the details of the described arrangements; changes and modifications may be made without departing from the scope of the appended claims.

What is claimed is:

1. A walking assist apparatus, having:
a support member that is adapted to support an user;
a pair of shoe units that are adapted to accommodate feet of the user;
a pair of leg links each having a first link connected to the support member through a first joint and a second link connected to each of the shoe units through a second joint;
actuators each connected to the first links and second links:
a controller that controls operation of the actuators; and
a battery that is adapted to supply operating power at least one of the actuators and the controller;
and assists walking of the user by operating the actuators to produce relative movement between the first and second links;
wherein the improvement comprises:
a primary coil installed in a floor on which the user walks on;
a secondary coil that is installed in at least one of the shoe units and is supplied with non-contact supply of power by magnetic induction from the primary coil; and
a charging circuit that charges the battery with direct current output rectified by a rectifier circuit.

2. The apparatus according to claim 1, wherein the secondary coil is installed at a location close to a heel end of the one of the shoe units.

3. The apparatus according to claim 1, wherein the primary coil is installed in the floor at a location midway of a travel circuit, when the user makes regular movement through the travel circuit.

4. The apparatus according to claim 3, a site of the midway is determined according to a capacity of the battery.

5. The apparatus according claim 1, wherein the secondary coil is wound in a circle such that the at least one of the shoe units fits in the circle with room to spare.

6. The apparatus according to claim 1, wherein the primary coil is embedded in the floor and covered by a cover.

7. The apparatus according to claim 1, wherein the primary coil is installed in the floor inside a carpet.
